(19) United States
(12) Patent Application Publication
(10) Pub. No.: US 2011/0001963 A1
(43) Pub. Date: Jan. 6, 2011

(54) SYSTEM AND METHOD FOR THE MEASUREMENT OF MULTIPLE EMISSIONS FROM MULTIPLE PARALLEL FLOW CHANNELS IN A FLOW CYTOMETRY SYSTEM

(76) Inventor: Gary P. Durack, Urbana, IL (US)

Correspondence Address: Woodard, Emhardt, Moriarty, McNett & Henry LLP;Sony Corporation, 111 Monument Circle, Suite 3700, Indianapolis, IN, 46204-5137, US

(21) Appl. No.: 12/827,661

(22) Filed: Jun. 30, 2010

Related U.S. Application Data
(60) Provisional application No. 61/222,509, filed on Jul. 2, 2009.

(51) Int. Cl. G01J 3/44; G01J 1/58

(52) U.S. Cl. 356/301; 250/458.1; 250/459.1; 356/338

(57) ABSTRACT

A system and method for the measurement of multiple emissions in multiple flow channels in a flow cytometry system is disclosed where each excitation source is modulated with a different frequency. A single detector is used to collect the fluorescent emissions excited by all sources in all flow channels, and the emissions are segregated using Fourier Transform techniques. The system and method are well-suited to microfluidic applications.

### CROSS-REFERENCE TO RELATED APPLICATIONS

The present application claims the benefit of U.S. Provisional Patent Application No. 61/222,509, which was filed Jul. 2, 2009 and is hereby incorporated herein by reference in its entirety.

### TECHNICAL FIELD OF THE DISCLOSURE

The present disclosure generally relates to flow cytometry systems and, more particularly, to a system and method for the measurement of multiple emissions from multiple parallel flow channels in a flow cytometry system.

### BACKGROUND OF THE INVENTION

Flow cytometry-based cell sorting was first introduced to the research community more than 20 years ago. It is a technology that has been widely applied in many areas of life science research, serving as a critical tool for those working in fields such as genetics, immunology, molecular biology and environmental science. Unlike bulk cell separation techniques such as immuno-panning or magnetic column separation, flow cytometry-based cell sorting instruments measure, classify and then sort individual cells or particles serially at rates of several thousand cells per second or higher. This rapid “one-by-one” processing of single cells has made flow cytometry a unique and valuable tool for extracting highly pure sub-populations of cells from otherwise heterogeneous cell suspensions.

Cells targeted for sorting are usually labeled in some manner with a fluorescent material. The fluorescent probes bound to a cell emit fluorescent light as the cell passes through a tightly focused, high intensity, light beam (typically a laser beam). A computer records emission intensities for each cell. These data are then used to classify each cell for specific sorting operations. Flow cytometry-based cell sorting has been successfully applied to hundreds of cell types, cell constituents and microorganisms, as well as many types of inorganic particles of comparable size.

Flow cytometers are also applied widely for rapidly analyzing heterogeneous cell suspensions to identify constituent sub-populations. Examples of the many applications where flow cytometry cell sorting is finding use include isolation of rare populations of immune system cells for AIDS research, isolation of genetically atypical cells for cancer research, isolation of specific chromosomes for genetic studies, and isolation of various species of microorganisms for environmental studies. For example, fluorescently labeled monoclonal antibodies are often used as “markers” to identify immune cells such as T lymphocytes and B lymphocytes, clinical laboratories routinely use this technology to count the number of “CD4 positive” T cells in HIV infected patients, and they also use this technology to identify cells associated with a variety of leukemia and lymphoma cancers.

Recently, two areas of interest are moving cell sorting towards clinical, patient care applications, rather than strictly research applications. First is the move away from chemical pharmaceutical development to the development of biopharmaceuticals. For example, many new cancer therapies utilize biological material. These include a class of antibody-based cancer therapeutics. Cytometry-based cell sorters can play a vital role in the identification, development, purification and, ultimately, production of these products.

Related to this is a move toward the use of cell replacement therapy for patient care. Much of the current interest in stem cells revolves around a new area of medicine often referred to as regenerative therapy or regenerative medicine. These therapies may often require that large numbers of relatively rare cells be isolated from patient tissue. For example, adult stem cells may be isolated from bone marrow and ultimately used as part of a re-infusion back into the patient from whom they were removed. Flow cytometry and cell sort are important tissue processing tools that enable delivery of such therapies.

There are two basic types of cell sorters in wide use today. They are the “droplet cell sorter” and the “fluid switching cell sorter.” The droplet cell sorter utilizes micro-droplets as containers to transport selected cells to a collection vessel. The micro-droplets are formed by coupling ultrasonic energy to a jetting stream. Droplets containing cells selected for sorting are then electrostatically steered to the desired location. This is a very efficient process, allowing as many as 90,000 cells per second to be sorted from a single stream, limited primarily by the frequency of droplet generation and the time required for illumination.

A detailed description of a prior art flow cytometry system is given in United States Published Patent Application No. US 2005/0112541 A1 to Durack et al.

Droplet cell sorters, however, are not particularly biosafe. Aerosols generated as part of the droplet formation process can carry biohazardous materials. Because of this, biosafe droplet cell sorters have been developed that are contained within a biosafety cabinet so that they may operate within an essentially closed environment. Unfortunately, this type of system does not lend itself to the sterility and operator protection required for routine sorting of patient samples in a clinical environment.

The second type of flow cytometry-based cell sorter is the fluid switching cell sorter. Most fluid switching cell sorters utilize a piezoelectric device to drive a mechanical system which diverts a segment of the flowing sample stream into a collection vessel. Compared to droplet cell sorters, fluid switching cell sorters have a lower maximum cell sorting rate due to the cycle time of the mechanical system used to divert the sample stream. This cycle time, the time between initial sample diversion and when stable non-sorted flow is restored, is typically significantly greater than the period of a droplet generator on a droplet cell sorter. This longer cycle time limits fluid switching cell sorters to processing rates of several hundred cells per second. For the same reason, the stream segment switched by a fluid cell sorter is usually at least ten times the volume of a single micro-drop from a droplet generator. This results in a correspondingly lower concentration of cells in the fluid switching sorter's collection vessel as compared to a droplet sorter's collection vessel.

Newer generation microfluidics technologies offer great promise for improving the efficiency of fluid switching devices and providing cell sorting capability on a chip similar in concept to an electronic integrated circuit. Many microfluidic systems have been demonstrated that can successfully sort cells from heterogeneous cell populations. They have the advantages of being completely self-contained, easy to sterilize, and can be manufactured on sufficient scales (with the resulting manufacturing efficiencies) to be considered a disposable part.

A generic microfluidic device is illustrated in FIG. 1 and indicated generally at 1. The microfluidic device 1 comprises a substrate 2 having a fluid flow channel 3 formed therein by any convenient process as is known in the art. The substrate 2 may be formed from glass, plastic or any other convenient material, and may be substantially transparent or substantially transparent in a portion thereof. The substrate 2 further has three ports 4, 5 and 6 coupled thereto. Port 4 is an inlet port for a sheath fluid. Port 4 has a central axial passage that is in fluid communication with a fluid flow channel 7 that joins fluid flow channel 3 such that sheath fluid entering port 16 from an external supply (not shown) will enter fluid flow channel 7 and then flow into fluid flow channel 3. The sheath fluid supply may be attached to the port 4 by any convenient coupling mechanism as is known to those skilled in the art.

Port 5 also has a central axial passage that is in fluid communication with a fluid flow channel 3 through a sample injection tube 8. Sample injection tube 8 is positioned to be coaxial with the longitudinal axis of the fluid flow channel 3. Injection of a liquid sample of cells into port 5 while sheath fluid is being injected into port 4 will therefore result in the cells flowing through fluid flow channel 3 surrounded by the sheath fluid. The dimensions and configuration of the fluid flow channels 3 and 7, as well as the sample injection tube 8 are chosen so that the sheath/sample fluid will exhibit laminar flow as it travels through the device 1, as is known in the art. Port 6 is coupled to the terminal end of the fluid flow channel 3 so that the sheath/sample fluid may be removed from the microfluidic device 1.

While the sheath/sample fluid is flowing through the fluid flow channel 3, it may be analyzed using cytometry techniques by shining an illumination source through the substrate 2 and into the fluid flow channel 3 at some point between the sample injection tube 8 and the outlet port 6. Additionally, the microfluidic device 1 could be modified to provide for a cell sorting operation, as is known in the art.

However, these microfluidic technologies have not been widely adopted largely due to cost considerations related to the maximum cell sorting throughput achievable on such a device. The fastest of the microfluidic cell sorters operate at rates of 1000 to 2000 cells per second, nearly 40 times slower than currently available droplet cell sorting systems. Microfluidic proponents suggest the possibility of massively parallel sorting channels integrated onto a single disposable chip to increase the total throughput to the same order of magnitude of the droplet cell sorting systems. This is an attractive proposition on the surface, until one analyzes the cost of providing all of the components required to make a functioning cell sorter using the massively parallel microfluidic chip. The lasers, optical filters, photodetectors, and data acquisition elements sum to several thousands of dollars per cell sorting channel. While a 40 channel microfluidic sorting system can match the throughput of a single droplet-based cell sorting system, most potential users are not willing (or able) to pay 40 times the cost for the rest of the required system components. For example, a typical cost for the lasers, optical filters, photodetectors, and data acquisition elements required for a single cell sorting channel can easily be $15,000, so a 40 channel microfluidic sorting system would cost over $600,000 to manufacture, and this price would be marked up for retail sale to allow a profit to the manufacturer. This can be compared to the $350,000 retail price of a typical single flow channel droplet-based cell sorter.

There is therefore a need in the prior art for improvements to cytometry systems employing multiple parallel flow channels in order to achieve required throughput rates at a system cost that is competitive with droplet based cell sorters. The present invention is directed to meeting this need.

### SUMMARY OF THE DISCLOSURE

A system and method for the measurement of multiple emissions in multiple flow channels in a flow cytometry system is disclosed where each excitation source is modulated with a different frequency. A single detector is used to collect the fluorescent emissions excited by all sources in all flow channels, and the emissions are segregated using Fourier Transform techniques. The system and method are well-suited to microfluidic applications.

In one embodiment, a flow cytometer for measuring emission from particles is disclosed, the flow cytometer comprising a first flow channel, a first excitation electromagnetic radiation source producing a first modulated excitation beam modulated at a first frequency, said first modulated excitation beam being incident upon said first flow channel, a second flow channel, a second excitation electromagnetic radiation source producing a second modulated excitation beam modulated at a second frequency, said second frequency being different than said first frequency, said second modulated excitation beam being incident upon said second flow channel, a detector adapted to measure emission from any of said particles when said particles are within either said first or second flow channel, said detector producing a detector output signal, and a signal processor operatively coupled to said detector for receipt of said detector output signal, said signal processor operative to distinguish a first portion of said detector output signal caused by emission from one of said particles by said first modulated excitation beam and a second portion of said detector output signal caused by emission from another one of said particles by said second modulated excitation beam.

In another embodiment, a method for measuring emissions from particles in a flow cytometer having first and second flow channels is disclosed, comprising the steps of: a) providing a first excitation electromagnetic radiation source; b) modulating said first excitation electromagnetic radiation source at a first frequency to produce a first modulated excitation beam; c) causing said first modulated excitation beam to be incident upon said first flow channel; d) providing a second excitation electromagnetic radiation source; e) modulating said second excitation electromagnetic radiation source at a second frequency to produce a second modulated excitation beam, said second frequency being different than said first frequency; f) causing said second modulated excitation beam to be incident upon said second flow channel; g) detecting emission from any of said particles in either of said first and second flow channels and producing a single detector output signal; and h) determining from said single detector output signal a first portion of said detected emission caused by excitation of one of said particles by said first modulated excitation beam and a second portion of said detected emission caused by excitation of another one of said particles by said second modulated excitation beam.

Other embodiments are also disclosed.

### BRIEF DESCRIPTION OF THE DRAWINGS

FIG. 1 is a schematic perspective view of a prior art microfluidic device.

FIG. 2 is schematic diagram of fluid flow paths, excitation lasers and fluorescence detectors in a prior art multiple channel flow cytometry system.

FIG. 3 is a schematic diagram of a multiple channel flow cytometry system according to a first embodiment of the present disclosure.

FIG. 4 is a schematic diagram of a multiple channel flow cytometry system according to a second embodiment of the present disclosure.

FIG. 5 is a schematic diagram of an integrated multiple channel flow cytometry system according to a third embodiment of the present disclosure.

FIG. 6 is a schematic diagram of an integrated multiple channel flow cytometry system according to a fourth embodiment of the present disclosure.

FIG. 7 is a schematic flow diagram of a first embodiment method for conducting multiple channel flow cytometry of the present disclosure.

### DETAILED DESCRIPTION OF THE VARIOUS EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated devices and methods, and such further applications of the principles of the invention as illustrated therein being contemplated as would normally occur to one skilled in the art to which the invention relates are intended to be protected.

From the description below, those skilled in the art will recognize that the present embodiments may be utilized with any parallel channel system, and are not applicable solely to microfluidic systems, such being only a convenient environment in which to describe the concepts of the present invention. It should also be noted that, as used herein, the term “parallel” is intended to encompass any number of flow channels operating in parallel, regardless of whether such channels are physically parallel to one another, or even physically proximate to one another.

The present embodiments disclosed herein comprise a scalable approach for sharing optical detection components, data acquisition channels, and sort decision processors among many microfluidic channels. Some of the presently disclosed embodiments will, for example, reduce the cost of implementing a 40 parallel channel microfluidic sorting system to nearly the same cost as a droplet cell sorting channel with the same effective throughput. Some of the present embodiments illustrate ways to utilize excitation lasers that are differently modulated for each of a plurality of parallel flow channels. The disclosed techniques can then be used to separate emission from different microfluidic flow channels using a single detection channel.

As will be appreciated from the disclosure herein, the techniques disclosed herein can be applied to systems in which the parallel flow channels share the same sample source, as well as systems designed to sort different particle samples simultaneously. It will further be appreciated that the techniques disclosed herein can be applied to a microfluidic sorting system comprising a combination of parallel sorting and/or serial sorting and/or detection modules. The sorted fractions may be collected in the same collection vessel or in multiple collection vessels. For example, a hierarchy of microfluidic sorting channels may be constructed and arranged to operate much like a decision tree, with multiple sorting paths, gates and detection points. Further, one can utilize lasers with different wavelengths at each detection point or utilize the present techniques to differentiate emission from multiple detection points that the cells pass through serially. Thus, the present embodiments allow a single photo-detection, signal processing path and sort control system to interact with multiple sorting and/or detection modules independent of the structure or arrangement of the flow channels, for example with parallel, serial and/or decision tree flow structures. The techniques disclosed herein can also be used with droplet sorting techniques, where the cells are sorted by asynchronously producing droplets from the flow channel fluid stream by any desired method.

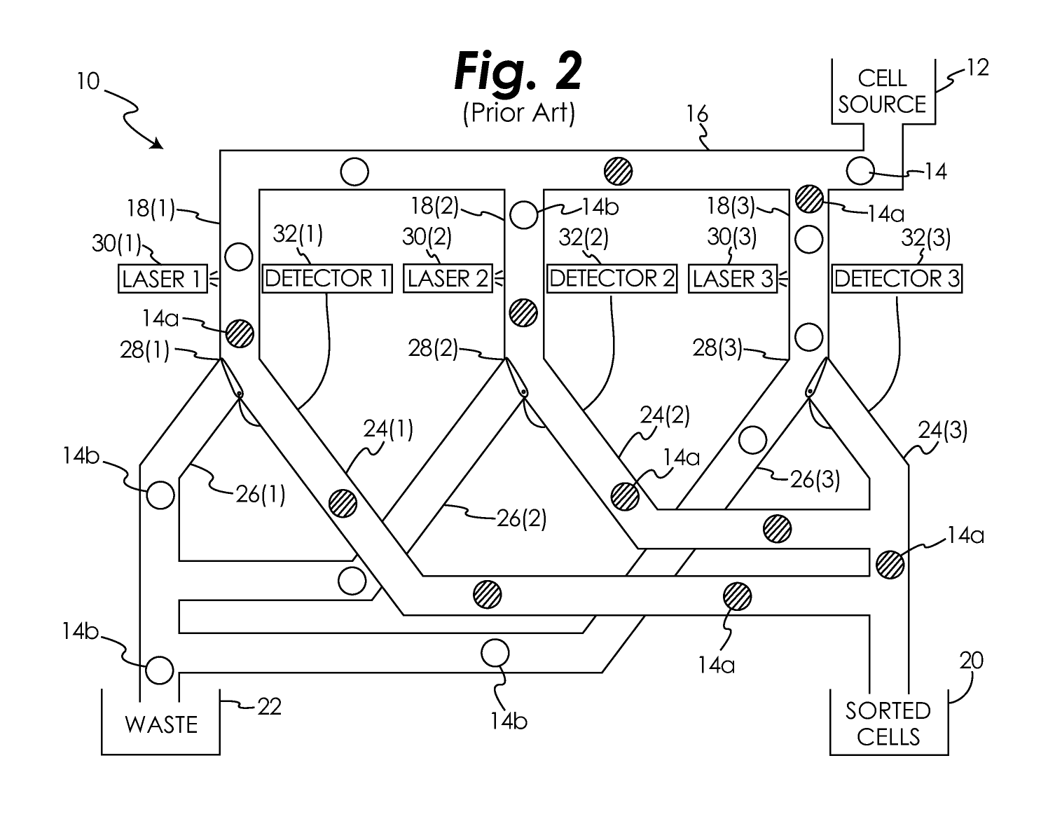

FIG. 2 schematically illustrates how sorting of particles might be done with a prior art multi-channel parallel flow arrangement, the system being indicated generally at 10. The disclosed embodiments are for use in a high speed cell sorting application. As used herein, the words “cell” and “particle” are interchangeable. Although “cell” refers to a biological material and “particle” refers to non-biological material, the systems and methods disclosed herein work with either cells or particles, therefore the words are interchangeable in the present disclosure and claims. A source 12 supplies the cells that are desired to be sorted. Individual cells 14 from cell source 12 flow down supply channel or path 16 and are randomly introduced to one of three sorting channels 18(1), 18(2) and 18(3). Those skilled in the art will appreciate that three sorting channels are shown for illustration purposes only, and that the number of potential sorting channels is unlimited. For further purposes of illustration, let us assume that cells 14 are of two types, 14a and 14b, wherein it is desired to sort cells 14a into sorted cell receptacle 20, while cells 14b are to be discarded into waste receptacle 22.

Each of the sorting channels 18 bifurcates into a sort passage 24, which couples to sorted cell receptacle 20, and a waste passage 26, which couples to waste receptacle 22. Whether the flow of cells is directed toward the sort passage 24 or the waste passage 26 in each sorting channel 18 is determined by the position of a flow diverter 28. In one embodiment, the flow diverter 28 is a piezoelectric device that can be actuated with an electric command signal in order to mechanically divert the flow through the sorting channel 18 into either the sort passage 24 or the waste passage 26, depending upon the position of the flow diverter 28. In other embodiments, flow diverter 28 is not a piezoelectric device, but instead can be, for example, an air bubble inserted from the wall to deflect the flow, a fluid deflector moved or actuated by a magnetic field or any other flow diverter or sorting gate as would occur to one of ordinary skill in the art.

In order to determine what position the flow diverter 28 should be placed in during any point in the cell sorting process, cells flowing through the cell sorting channels 18 are subjected to electromagnetic excitation from an excitation light source 30. Excitation light sources 30 may comprise, for example, laser light sources, such as a laser or laser emitting diode (LED) to name just two non-limiting examples. Each laser 30 is positioned such that a cell traveling down sorting channel 18 will pass through the beam of the laser 30. A corresponding detector 32 is positioned at each sorting channel 18 in order to receive any fluorescent emission that may be given off by a cell 14 as it passes through the excitation laser 30 light beam. Emissions other than fluorescence may instead be detected, such as Raman scatter, phosphorescence, luminescence, or scatter, just to name a few non-limiting examples.

Alternatively, several paired laser paths and detectors can be associated with one sort diverter. Such beam path/detection pairs can be aligned serially in the flow path prior to the diverter. It is also possible to have multiple lasers aligned collinearly, each modulating at a different frequency, allowing one PMT to measure multiple emissions, as is disclosed in U.S. Patent Application Publication No. US 2008/0213915 A1 entitled SYSTEM AND METHOD FOR MEASUREMENT OF MULTIPLE FLUORESCENT EMISSIONS IN A FLOW CYTOMETRY SYSTEM, the contents of which are hereby incorporated by reference.

In one embodiment, detector 32 comprises detection optics, such a lens, band-pass optical filter, and photomultiplier tube, that will sense radiation emitted within the passband of the optical filter by the cell 14 and produce an analog electrical signal that varies with the intensity of the received radiation. This analog output may then be conveniently converted to a digital signal that can be analyzed by a digital signal processor in order to determine if the fluorescence emission characteristics, indicated in the time-varying signal or pulse, match the set of characteristics previously established for sorting. If the characteristics match, cell 14 is appropriately tagged and should be sorted into the sorted cell receptacle 20. Therefore, depending upon the radiation detected by the detector 32, the flow diverter 28 is positioned in order to direct the cell 14 into the appropriate receptacle. Because each sorting channel 18 has a laser 30, detector 32 and associated flow diverter 28, as many sorting channels 18 as are desired can be operated in parallel in order to achieve the desired throughput of the system 10.

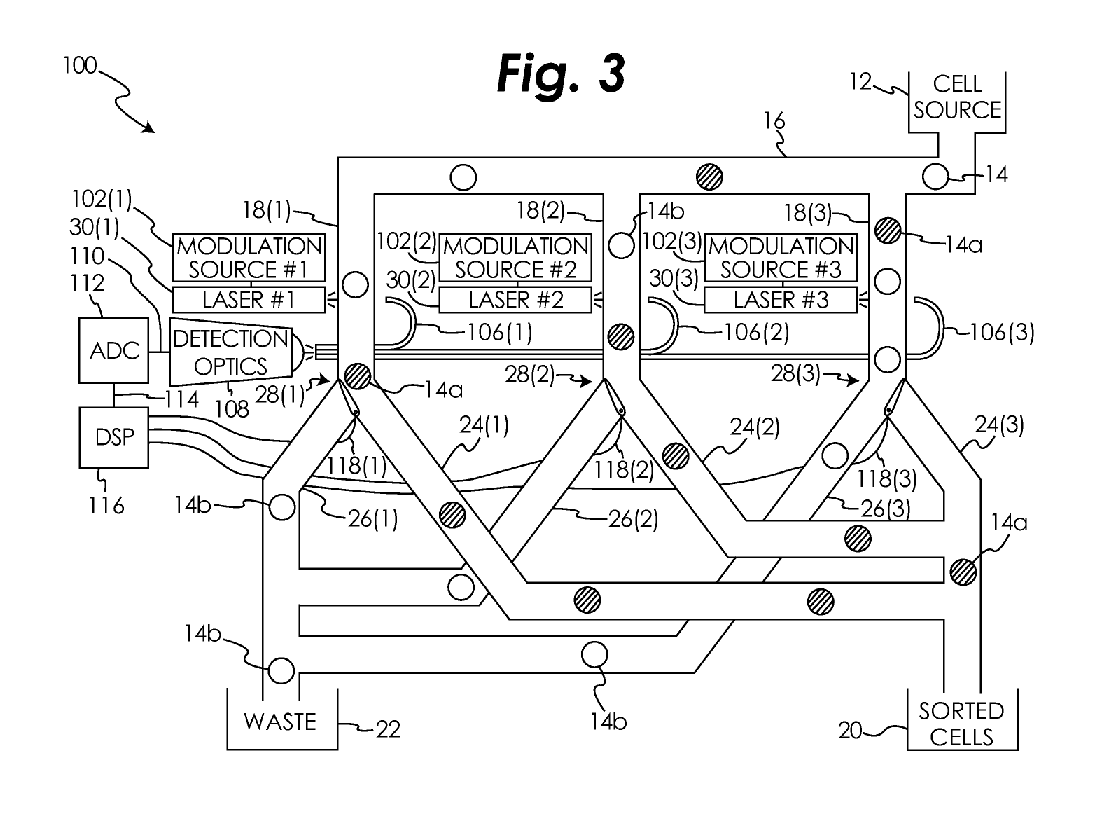

As discussed hereinabove, the arrangement of FIG. 2 suffers from the cost associated with the electronic systems needed to operate each sorting channel 18. As the number of sorting channels increase in order to achieve the desired sorting throughput, the amount of the electronics systems that are needed increases at the same pace, quickly making the system 10 uneconomical. In order to ameliorate this disadvantage, the presently disclosed embodiments comprehend a modification of the system 10 as shown schematically in FIG. 3 and indicated generally at 100. Like reference designators are used for like portions of the systems 10 and 100.

In the system 100 each of the excitation lasers 30 are modulated (e.g., by amplitude modulation) in one embodiment with an appropriate function (such as a sinusoid function (sin or sin²) to name just one non-limiting example) at specific known frequencies. The present invention also comprehends that the lasers 30 may be modulated using any modulation scheme, such as amplitude modulated, frequency modulated or phase modulated, just to name a few non-limiting examples. Many diode lasers can be directly modulated using transistor-transistor logic (TTL) gating (one example of such a laser is the CUBE laser series from Coherent, Inc., 5100 Patrick Henry Drive, Santa Clara, Calif. 95054) or by introducing a periodic signal (sine wave, square wave) into the electronics driving the diode laser. Many lasers produce highly periodic pulse trains due to their physical cavity design. An example of such a laser is the VANGUARD 350-HMD 355 laser (available from Newport Corporation, 1791 Deere Avenue, Irvine Calif. 92606) which produces pulses at a frequency of approximately 80 MHz. Lower modulation frequencies can be achieved by using an electro-optic modulator (EOM) or an acousto-optic modulator (AOM). EOMs and AOMs are used to introduce amplitude, phase, or frequency modulation onto continuous-wave (CW) laser beams. Additionally, modulation can be performed by rapidly sweeping the beam across channels using a reflector mounted on a galvanometer or on a rotating mirror having multiple flat sides. It will be appreciated that the various embodiments disclosed herein can be used with amplitude, phase or frequency modulation, or a combination of these techniques. Any method of producing periodic excitation in the light source will produce periodic fluorescence emission from the fluorescent tag that can be analyzed using the systems and methods described herein.

In the case of cell sorting using microfluidic technologies, cells flow past the optical system at typical velocities of 0.1 to 5 m/s (depending on the fluid pressure employed). Further, it is possible to implement high pressure microfluidic systems having pressures of up to 90 psi if it is acceptable for multiple cells to be sorted in a single gate switch. This produces dwell times (the time it takes a particle to traverse the measurement region or move through the laser beam focus) in the optical measurement region of 10 to 100 microseconds, as well as dwell times of 0.5 to 10 microseconds for high pressure systems. Both higher and lower velocity systems can also be employed that could result in dwell times of 500 nanoseconds to 10 milliseconds. Because it is desirable to have >2 periods of the modulation occur during the dwell time, modulation frequencies may preferably be between about 10 KHz and 1 GHz. In certain embodiments of the microfluidics cell sorter disclosed herein, the modulation frequencies are between 20 KHz and 500 KHz.

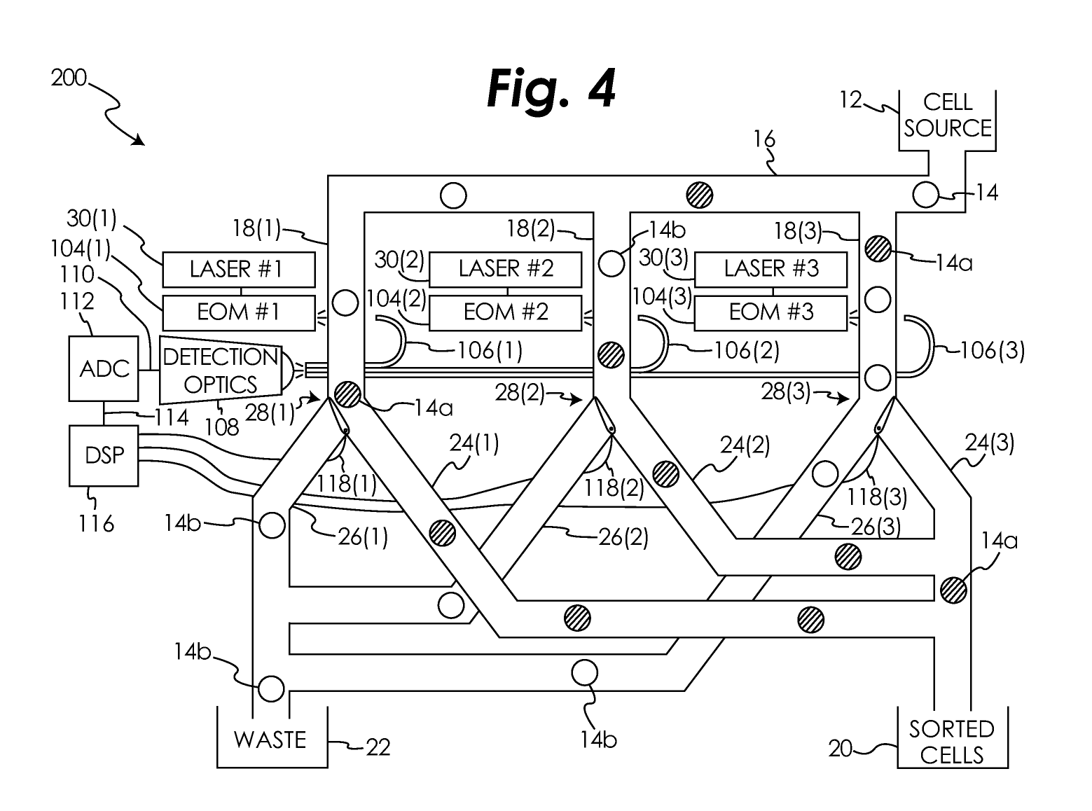

In one embodiment, such modulation is accomplished using modulated power sources 102(1) through 102(3) that are used to drive the excitation lasers 30(1) through 30(3). In another embodiment, schematically illustrated in FIG. 4, an electro-optic modulator (EOM) may be used to modulate the light emitted from each excitation laser. An electro-optic modulator is an optical device in which a signal-controlled element is used to modulate a beam of light. It is based on the linear electro-optic effect (also called Pockels effect), i.e., the modification of the refractive index of a nonlinear crystal by an electric field in proportion to the field strength. The modulation may be imposed on the phase, frequency, amplitude, or direction of the modulated beam. Modulation bandwidths extending into the gigahertz range are possible with the use of appropriate modulators. When using EOMs, the EOMs 104(1) through 104(3) are placed to receive the output of each respective excitation laser 30, as is shown in the second embodiment flow cytometry system 200 of FIG. 4. In either arrangement, each excitation light source 30 is amplitude modulated at a different frequency and/or in a different manner. In another embodiment, an acousto-optic modulator (AOM) may be used to modulate the light emitted from each excitation laser. An AOM, also referred to as a Bragg cell, uses the acousto-optic effect to diffract and shift the frequency of light using sound waves. AOMs are much faster than typical mechanical devices (like mechanical choppers which are sometimes used to modulate laser beams), because the time it takes an AOM to shift the exiting beam is roughly limited to the transit time of the sound wave across the beam, typically 5 to 100 nanoseconds. AOMs may be used at frequencies up to about 1 MHz. When faster control is necessary, EOMs may be used. However, these require very high voltages, up to 10 kilovolts, whereas AOMs offer more deflection range, simple design, and low power consumption.

The individual modulated excitation beams from lasers 30(1) through 30(3) are aimed at a single point (the detection volume) within their respective sorting channels 18, through which cells 14 in the flow cytometer pass as they traverse the sorting channel 18. Interaction of the excitation beam from the laser 30 with a cell 14 may result in a fluorescence emission. Rather than have a detector 32 positioned adjacent each sorting channel 18 in order to receive such fluorescent emission, the embodiment of FIG. 3 captures this emission with a fiber optic cable 106. The fiber optic cables 106(1) through 106(3) all transmit the emissions that they receive to the detection optics 108. Detection optics 108 therefore simultaneously receives any emission signal that may be present at all of the sorting channels 18. Those skilled in the art will recognize that any means may be employed to transmit the emissions from the various sorting channels to the detection optics, such as reflective channels, waveguides, light pipes, and linear optics. Additionally, if the sorting channels are physically close enough together, the detection optics may be placed such that the sorting channels are all within the field of view of the detection optics, in which case the detection optics directly receives the emissions. It is contemplated that detection optics 108 may comprise either a singular optic or a plurality of optics.

Detection optics 108 focuses the combined fluorescence emissions of all of the sorting channels 18 onto a photodetector (not shown), such as a photomultiplier tube (PMT) operating in analog mode (not photon counting). In front of the PMT are preferably located optical filters that discriminate a particular spectral band of interest (i.e. the expected band of fluorescence emitted by the labeling fluorescent molecules). In some embodiments, such as when the system 100 is being used to sense multiple cell types labeled with different fluorescent tags, a single set of optics will transmit the emission to multiple PMTs, each having an associated bandpass filter that allows one range of expected emission frequencies to pass to the PMT. A network of long-pass and short-pass dichroic filters can be used to split off portions of the emission spectra and direct appropriate portions into the bandpass filters in front of the PMTs. For example, the emission can be coupled into a fiber optic system and then input into multiple PMTs. Optical filters, including narrow-band notch filters, may be employed to block intense laser light scatter from the sorting channel stream or particles.

In one embodiment, the PMT and associated amplification system have a bandwidth of approximately 45 MHz (0.5-45 MHz). This bandwidth is selected such that it includes all of the modulation frequencies employed, however the highest passed frequency is preferably less than 2.5 times the digital sampling frequency used for data acquisition. The Nyquist theorem states that to prevent harmonic artifacts in digital sampled data, the frequency content of the signal must be limited to less than two times the sampling frequency. The analog signal 110 out of the detection optics 108 is continuously sampled at a rate greater than the Nyquist frequency by analog-to-digital converter (ADC) 112 to produce a digitized version 114 of the detected analog signal 110. In one embodiment, the ADC 112 utilizes a sample rate of 105 MHz using a 14 bit ADC.

In another embodiment, ADC 112 utilizes a sample rate of 200 KHz using a 16 bit audio ADC. In this embodiment, the PMT and associated amplification system have a bandwidth of approximately 80 KHz. In some embodiments where multiple PMTs are used, a separate ADC is preferably used to sample the analog output of each PMT. The digitized data stream 114 is analyzed in a suitable data processor, such as digital signal processing system (DSP) 116 using appropriate software. In other embodiments where multiple PMTs are used, the outputs from all of the PMTs are mixed together to create a single signal that is a composite of the signals from all of the detectors. A single ADC can then be used to sample the analog output of all of the PMTs. For example, the system can comprise 40 channels and three emission bands. A PMT may be used for each of the three emission bands, while only one ADC is used to analyze the combined outputs from the three PMTs. This represents a considerable savings over prior art approaches, where three detectors would be needed for each of the 40 channels, requiring 120 separate ADCs. As with the prior embodiment, the digitized data stream 114 from the single ADC is analyzed in a suitable data processor, such as digital signal processing system (DSP) 116 using appropriate software. In still other embodiments, rather than using digital signal processing techniques a series of passive or active electronic bandpass filters are used to extract the modulated emission intensities for each channel An ADC is then used to measure the power passing through each such filter.

This software analyzes and detects particle emissions recorded in the data resulting from the digitized waveform produced by the electrical pulse from the PMT which resulted from fluorescence emission of the fluorescent molecules in the cell 14. The fluorescence emission was produced by the fluorescently labeled cells 14 passing through the excitation produced by one of the lasers 30(1) through 30(3). Sinusoidal excitation of fluorescent molecules produces a nearly sinusoidal fluorescence emission intensity from those molecules. The phase shift of the modulated emission and the modulation depth of the modulated emission are related to the lifetime of the emission decay. The frequency of the modulated emission will match the frequency of the excitation source. The combined fluorescence emission of any cells 14 in all of the detection volumes of the sorting channels 18 is detected by detection optics 28 and, therefore, can be represented as a sum of sinusoidal functions, one frequency for each individual excitation laser 30 which caused a fluorescent emission from one of the cells 14.

By computing Discrete Time Fourier Transforms (DTFTs) at the known modulation frequencies of the excitation lasers 30 on the digital data 114 obtained by sampling the electrical signal 110 from the PMT, the DSP 116 determines the power present in the signal at each modulation frequency. This power is proportional to the total emissions of the fluorescent material due to excitation by the individual light source 30 which is modulated at that frequency. The DTFT computations may be used to unmix the combined multi-channel emission signal into its component parts, one for each laser 30, even if these emissions have overlapping spectral characteristics, and to derive the intensity of each separate emission component. Alternatively, Fast Fourier Transforms (FFTs) may be computed, especially in the case of slower microfluidic systems. In other embodiments, different mathematical algorithms may be used to extract the desired information.

It is desirable that modulation frequencies be chosen such that harmonics do not interfere with the measurements. For example, if 10 kHz is used then N×10kHz (i.e. 20 kHz, 30 kHz, 40 kHz, etc.) should be avoided. Therefore, the frequencies for each channel should be intelligently selected to avoid harmonics.

Upon determining these separate emission intensities for any particular sorting channel 18, the DSP 116 may use this information to determine how to classify and sort the cell by applying the appropriate control signal to the control line 118 (1) through 118(3) coupled to respective flow diverters 28(1) through 28(3). It should be noted that the system may also be used to analyze the samples but not sort them. In other words, the system may count particles to identify and quantify statistically significant populations within the entire sample, but not sort those populations into separate physical collections.

Another significant advantage over the prior art devices achieved with use of the presently disclosed embodiments is in the area of calibration. Each photodetector element will exhibit a unique responsivity (the relationship between the number of photons into the photodetector to the number of electrons out of the photodetector). When using, for example, 40 photodetectors in a system, there is required a complex calibration scheme in order to ensure that all of the measurement channels produce the same response. Otherwise, it would be necessary to sample data on each of the 40 channels and set unique sorting criteria for each channel in view of the responsivity of that channel Because the presently disclosed embodiments share the same photodetector and ADC for all channels, all channels are guaranteed to exhibit the same responsivity. It is possible that the modulation frequency may introduce some variation in the responsivity, but it is relatively unburdensome to sweep a single channel through the entire range of modulation frequencies in order to develop a standard calibration curve for use with the detection electronics. Since the primary source of variation is the detector and differences in signal-to-noise ratio among the detection paths, executing measurements received from many channels in a single detection path simplifies calibration substantially, in addition to the cost savings already discussed.

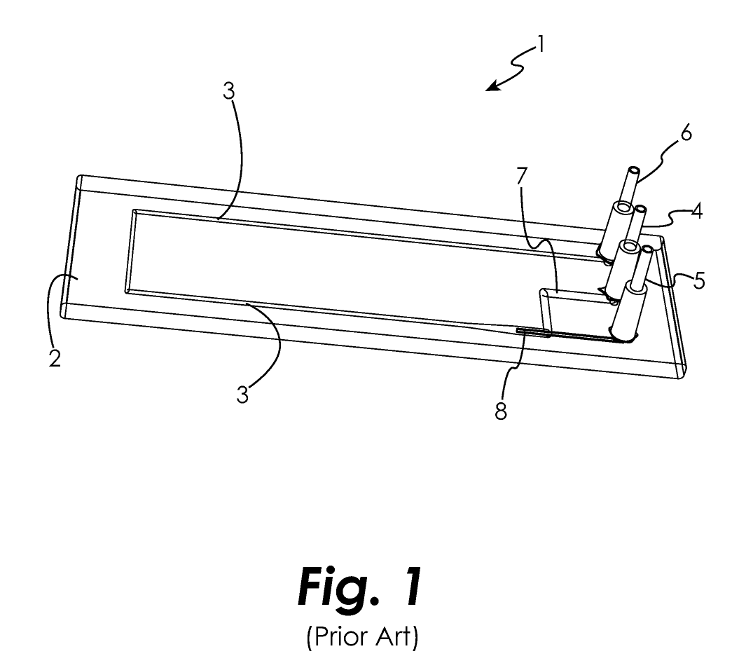

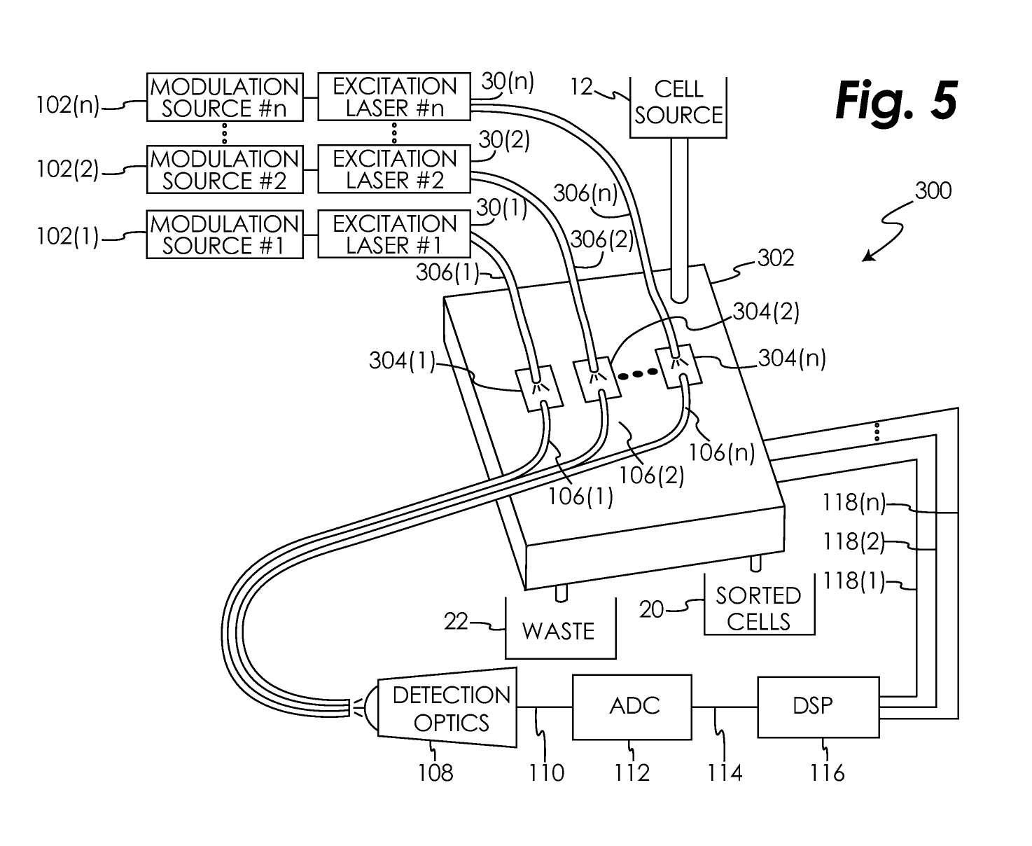

Referring now to FIG. 5, there is schematically shown another embodiment of the present invention, indicated generally at 300, in which the parallel sorting channels 18 are integrated into a discrete package. All of the flow channels illustrated in FIG. 3 are formed within the integrated substrate 302 using methods known in the art of microfluidics, such as those discussed above with respect to FIG. 1 and the like. Like reference designators are used to refer to like components. In the embodiment of FIG. 5, the substrate 302 is schematically shown containing n sorting channels 18, where n is any integer. The channels internal to the substrate 302 are coupled to the exterior of the substrate 302 to allow for connection of the cell source 12, the sorted cell receptacle 20, and the waste receptacle 22. Transparent windows 304(1) through 304(n) are formed in the substrate 302 over each sorting channel 18 in order allow light from external excitation sources 30(1) through 30(n) to be routed to the detection volume within each respective sorting channel 18(1) through 18(n) via any appropriate means, such as respective fiber optic cables 306(1) through 306(n). In certain embodiments, the entire substrate 302 is transparent. The excitation sources 30 are illustrated as being driven by modulation sources 102; however, the present invention also comprehends the use of other means to modulate the excitation source, such as EOMs 104, or AOMs, as described hereinabove.

Transparent windows 304(1) through 304(n) also allow fluorescent emissions from any cells in the sorting channels 18 to be captured by respective fiber optic cables 106(1) through 106(n) and delivered to the detection optics 108. Processing of the fluorescent emission signal is carried out as described hereinabove with respect to FIG. 3. The resulting command signals for the flow diverters 28(1) through 28(n) are provided to appropriate connectors on the substrate 302 over the lines 118(1) through 118(n).

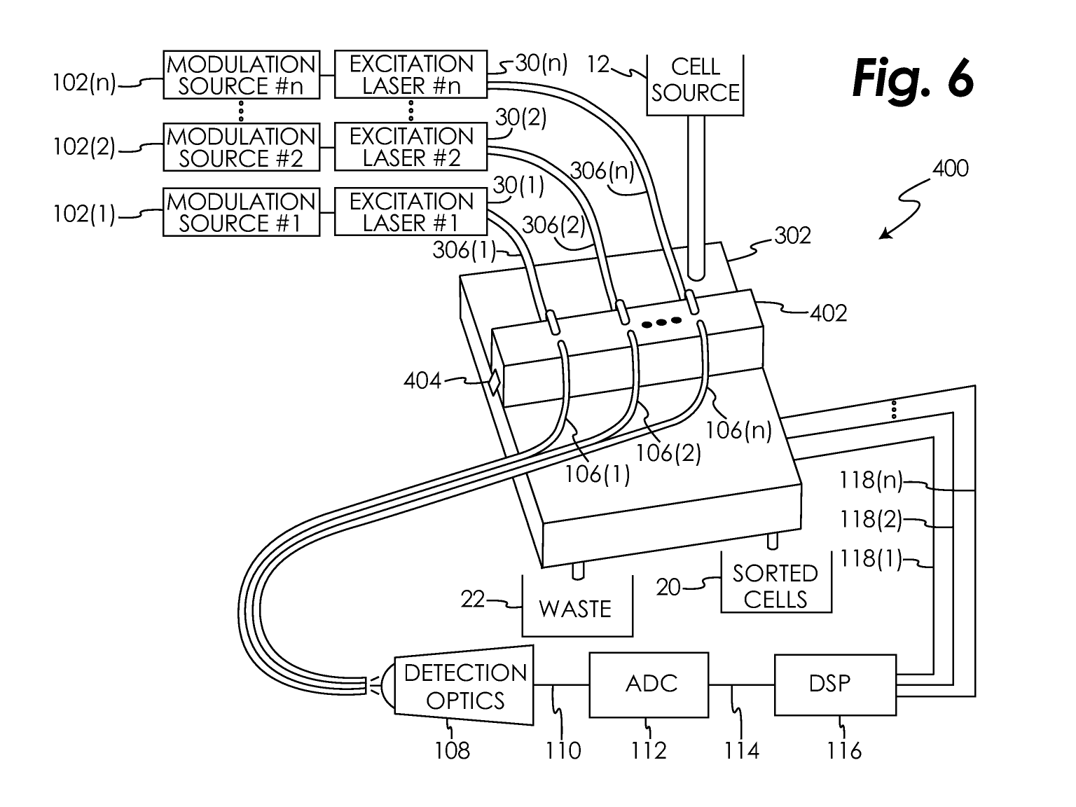

Manufacture of the flow channels within an integrated substrate 302 allows for volume production of the substrates 302, thereby reducing their cost and increasing their ease of use. In some embodiments, the substrate 302 is disposable after use, allowing a new substrate 302 to be used for sorting each new sample of cells. This greatly simplifies the handling of the sorting equipment and reduces the complexity of cleaning the equipment to prevent cross contamination between sorting sessions, because much of the hardware through which the samples flow is simply disposed of. The substrate 302 also lends itself well to sterilization (such as by gamma irradiation) before being disposed of. In order to facilitate the interchange of a new substrate 302, some embodiments include an excitation/read head 402 as schematically illustrated in the embodiment of FIG. 6, wherein the embodiment is indicated generally at 400. The excitation/read head 402 is simply an integrated assembly that holds the excitation fiber optic cables 306 and the emission fiber optic cables 106 in the desired orientation with respect to the transparent windows 304. Excitation/read head 402 may mount to the substrate 302 by means of clips 404 or any other connecting mechanism that ensures that the excitation/read head 402 is positioned at the appropriate position with respect to the transparent windows 304. When switching to a different substrate 302, all of the fiber optic cables may be disconnected and then reconnected as a single unit, thus greatly facilitating the operation.

It will be appreciated that the elimination of a separate detector for each sorting channel 18 by the presently disclosed embodiments significantly reduces the quantity of expensive optics, PMTs, and ADCs that would be required if redundant systems were supplied for each sorting channel 18. Use of the modulated light sources as disclosed herein allows for the use of a single detection section for all sorting channels. However, use of a single digital signal processor for all of the flow channels requires more computing power than would be necessary for a processor dedicated to only one of the sorting channels. For a high speed flow cytometry cell sorter using multiple parallel sorting channels (e.g. forty such channels), cells arrive at random intervals at average rates of up to 100,000 cells per second or more. By using the modulated excitation measurement described herein, classification and the sorting decision for each cell must be accomplished within a few hundred microseconds. The computations must be performed in real-time in order to sort the cells in each sorting channel 18 into the appropriate collection receptacles. The use of the DTFT algorithm and the high-speed processing architecture disclosed herein enable the achievement of a practical solution for cell sorting at these rates.

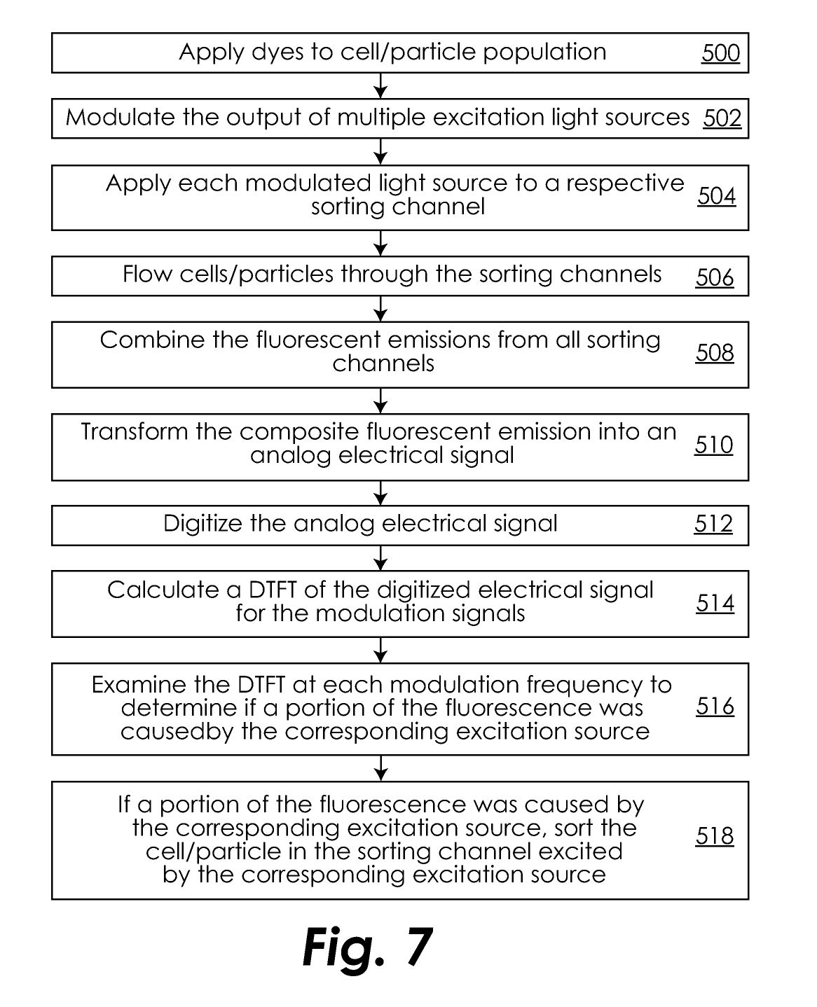

A schematic process flow diagram for detection of fluorescent emissions in parallel flow channels using the systems 100, 200, 300 and 400 is illustrated in FIG. 7. The process begins at step 500 where a single or multiple dyes are applied to the population of cells or other particles. Each particular dye used will have an excitation, or absorption spectra and a resultant fluorescence emission spectra. Fluorescent emission will always occur at longer wavelengths due to the physical property of fluorescence known as Stoke's shift. Some or all of the emission wavelengths from the various dyes may overlap. The dyes can be excited by one or more of the excitation sources.

At step 502, an excitation light source having an excitation wavelength corresponding to the excitation spectra of at least one of the dyes is modulated in a manner different than the other excitation light sources. For example, each excitation light source may be amplitude modulated with a sine function having a different frequency than all of the other modulation frequencies.

At step 504, the modulated output of each of the excitation light sources are applied to a respective sorting channel. Cells/particles from the population under study are flowed through the detection volume of the modulated excitation beam at step 506, causing fluorescent emissions corresponding to each dye present on the cell/particle.

The fluorescent emissions (if any) from all sorting channels are combined into a composite fluorescent emission at step 508. This fluorescent emission is transformed at step 510 by the detection optics of the system, producing an analog electrical signal corresponding to the time-varying intensity of the combined emission pulse. This analog signal is digitized at step 512 so that the data can be analyzed with use of digital signal processing equipment. A DTFT is performed on this digitized pulse signal at step 514 for at least the modulation frequencies of the individual excitation light sources. The value of the DTFT, calculated at each of these modulation frequencies, corresponds to the portion of the total output signal contributed by emissions resulting from each of the individual excitation light sources. These DTFT values are then examined at step 516 to determine whether each excitation source contributed to the total fluorescence emission. By determining whether the DTFT values at each modulation frequency fall within predetermined ranges, the system can determine whether the cell/particle that just passed through the detection volume of the corresponding sorting channel is marked with specific amounts of the corresponding dyes, and appropriate action can be taken to sort the cell/particle. For example, the cell/particle can be sorted into a segregated population at step 518.

The flow cytometry systems 100, 200, 300 and 400 can be used with any number of excitation light sources 30. It will be appreciated from the above description that the parallel channel flow cytometry systems disclosed herein represent a significant improvement over prior art parallel channel systems. Only a single detector 108 and associated signal processing circuitry is needed no matter how many excitation light sources 30 are used. Simultaneous, quantitative, fluorescence measurements from each excitation source can be made using the same optical elements and photodetector, removing variability introduced by prior multi-optical path, multi-detector implementations. Furthermore, since only a single detector is used, the number of channels in the system can be scaled upward in order to achieve the desired cell processing rate without significantly increasing the cost of the system and without significantly increasing the complexity of calibrating the system. It will be appreciated that all of these improvements offer significant performance advantages over the prior art flow cytometry systems.

Dynamic Range of the Detector

In some cases, there can be two potential problems associated with the previously described modulation technique. First, when multiple excitation lasers are being used with multiple sorting channels, fluorescent emission from more than one sample can occur simultaneously. Since, in practice, the photodetector has a limited measurement range (i.e. dynamic range of response), the amount of dynamic range available for measurement of the emission excited by each laser is not always constant, and is always less than for the case of a single laser emission. Additionally, in some cases, the minimum detection point of the fluorescence emission at any frequency that can be achieved through the use of modulation-based measurement techniques may be higher (poorer) than the minimum detection point that can be achieved by direct measurement of the total fluorescence emission (typical area flow cytometry parameter) when different excitation lasers do not have to be discriminated.

At lower frequencies, these problems can be ameliorated by using much higher resolution ADCs. For example, by using 22 bits of ADC resolution, it is possible to limit the maximum signal produced by each channel so that the dynamic range limit will not be reached.

The analysis method disclosed herein is well suited for implementation into any flow cytometer DSP system. DSP hardware is specifically designed for efficient performance of Fourier analyses such as that described above. Further, it may be noted that it is unnecessary to compute the energy content of the signal at all frequencies (up to the Nyquist rate)—all that is needed is the magnitude of the Fourier transform at the specific excitation laser modulation frequencies of interest. Thus rather than performing a computationally expensive Discrete Fourier Transform (DFT) or the somewhat more efficient implementation of this algorithm, known as the Fast Fourier Transform (FFT), the much more computationally efficient Discrete Time Fourier Transform (DTFT) may be computed for each frequency, making it possible to obtain the needed information in a maximum of a few microseconds. This means the process can be used for real-time cell sorting applications.

As discussed previously hereinabove, the presently disclosed embodiments allow for the use of a single photodetection/signal processing path and a sort control system that interacts with multiple detection/sorting modules, regardless of whether they are located in parallel, in serial, in a logical tree structure, or some combination of these. For example, if one desired to sort for a very rare occurrence, say a 1:1,000,000 event, then a system can be used in which the first sorting gate operates in a high throughput manner, sorting ten cells at a time (for example). In other words, the first sorting gate will look at ten cells at a time and they are selected if a fluorescent emission is detected (indicating that at least one of them was a particle being searched for). This means that with every cell chosen for sorting, there may be several cells sorted with it that do not meet the sorting criteria. For very rare occurrences, enriching the sample population up to 1:10 with this single gate would be a satisfactory result, and allowing this gate to sort multiple cells at a time effectively increases the front-end throughput of the sorting process. A second sorting gate or set of parallel gates can then receive the output of the enrichment sorting gate. These second gates can then complete the sorting process, knowing that at worst case the incoming sample purity is at least 10%.

In view of the foregoing, and while the invention has been illustrated and described in detail in the drawings and foregoing description, the same is to be considered as illustrative and not restrictive in character, it being understood that only illustrative embodiments have been shown and described and that all changes and modifications that come within the spirit of the invention are desired to be protected.

What is claimed:

1. A flow cytometer for measuring emission from particles, the flow cytometer comprising:
a first flow channel;
a first excitation electromagnetic radiation source producing a first modulated excitation beam modulated at a first frequency, said first modulated excitation beam being incident upon said first flow channel;
a second flow channel;
a second excitation electromagnetic radiation source producing a second modulated excitation beam modulated at a second frequency, said second frequency being different than said first frequency, said second modulated excitation beam being incident upon said second flow channel;
a detector adapted to measure emission from any of said particles when said particles are within either said first or second flow channel, said detector producing a detector output signal; and
a signal processor operatively coupled to said detector for receipt of said detector output signal, said signal processor operative to distinguish a first portion of said detector output signal caused by emission from one of said particles by said first modulated excitation beam and a second portion of said detector output signal caused by emission from another one of said particles by said second modulated excitation beam.

2. The flow cytometer of claim 1, further comprising:
a first flow diverter associated with said first flow channel and operatively couple to said signal processor; and
a second flow diverter associated with said second flow channel and operatively couple to said signal processor;
wherein said signal processor is operative to control said first flow diverter based upon said distinguished first portion of said detector output signal; and
wherein said signal processor is operative to control said second flow diverter based upon said distinguished second portion of said detector output signal.

3. The flow cytometer of claim 2, wherein said first and second flow diverters are selected from the group consisting of: piezoelectric devices, air bubble insertion means, and magnetically actuated fluid deflectors.

4. The flow cytometer of claim 1, wherein said particles comprise biological cells.

5. The flow cytometer of claim 1, wherein said first and second excitation electromagnetic radiation sources comprise lasers.

6. The flow cytometer of claim 1, wherein said emission comprises emission selected from the group consisting of: fluorescent emission, Raman scatter, phosphorescence, luminescence and scatter.

7. The flow cytometer of claim 1, wherein said detector comprises:
optics adapted to receive said emission and produce a lens output;
a band-pass optical filter adapted to receive said lens output and produce a filtered output; and
a photomultiplier tube adapted to receive said filtered output and produce said detector output signal comprising an analog electrical signal.

8. The flow cytometer of claim 7, further comprising:
an analog-to-digital converter having a converter input operatively coupled to said analog electrical signal, and further having a converter output operatively coupled to said signal processor.

9. The flow cytometer of claim 1, wherein said first and second excitation electromagnetic radiation sources each comprise:
a laser; and
a modulator operatively coupled to said laser for producing said modulated excitation beam.

10. The flow cytometer of claim 9, wherein said modulator is selected from the group consisting of: a TTL gating device, a periodic signal driving said excitation electromagnetic radiation source, electro-optic modulators, acousto-optic modulators, a reflector mounted on a galvanometer, and a reflector mounted on a rotating mirror having multiple flat sides.

11. The flow cytometer of claim 1, wherein said first and second modulated excitation beams are modulated using a modulation scheme selected from the group consisting of: amplitude modulation, phase modulation, and frequency modulation.

12. The flow cytometer of claim 1, further comprising:
a fiber optic cable having a first input adapted to capture said emission from one of said particles by said first modulated excitation beam, a second input adapted to capture said emission from one of said particles by said second modulated excitation beam, and an output adapted to provide said emissions to said detector.

13. The flow cytometer of claim 2, further comprising:
a microfluidic substrate, wherein said first and second flow channels and said first and second flow diverters are carried by said microfluidic substrate.

14. A method for measuring emissions from particles in a flow cytometer having first and second flow channels, comprising the steps of:
a) providing a first excitation electromagnetic radiation source;
b) modulating said first excitation electromagnetic radiation source at a first frequency to produce a first modulated excitation beam;
c) causing said first modulated excitation beam to be incident upon said first flow channel;
d) providing a second excitation electromagnetic radiation source;
e) modulating said second excitation electromagnetic radiation source at a second frequency to produce a second modulated excitation beam, said second frequency being different than said first frequency;
f) causing said second modulated excitation beam to be incident upon said second flow channel;
g) detecting emission from any of said particles in either of said first and second flow channels and producing a single detector output signal; and
h) determining from said single detector output signal a first portion of said detected emission caused by excitation of one of said particles by said first modulated excitation beam and a second portion of said detected emission caused by excitation of another one of said particles by said second modulated excitation beam.

15. The method of claim 1, further comprising the steps of:
i) diverting flow in said first flow channel based upon said first portion of said detected emission; and
j) diverting flow in said second flow channel based upon said second portion of said detected emission

16. The method of claim 15, wherein steps (i) and (j) each comprise actions selected from the group consisting of: actuating a piezoelectric device, inserting an air bubble into said respective flow channel, and magnetically actuating a fluid deflector.

17. The method of claim 14, wherein said particles comprise biological cells.

18. The method of claim 14, wherein steps (b) and (e) comprise modulating lasers.

19. The method of claim 14, wherein said emission comprises emission selected from the group consisting of: fluorescent emission, Raman scatter, phosphorescence, luminescence and scatter.

20. The method of claim 14, wherein step (g) comprises sensing said emission with a photomultiplier tube, said photomultiplier tube producing said single detector output signal.

21. The method of claim 14, wherein step (h) comprises performing a Fourier Transform on said single detector output signal.

22. The method of claim 21, wherein said Fourier Transform comprises a Discrete Time Fourier Transform.

23. The method of claim 14, wherein said first and second excitation electromagnetic radiation sources each comprise a laser.

24. The method of claim 18, wherein steps (b) and (e) each comprise actions selected from the group consisting of: activating a TTL gating device coupled to a laser diode, introducing a periodic signal into a drive signal for said excitation electromagnetic radiation source, operating an electro-optic modulator, operating an acousto-optic modulator, operating a reflector mounted on a galvanometer, and operating a reflector mounted on a rotating mirror having multiple flat sides.

25. The method of claim 14, wherein steps (b) and (e) comprise modulating said first and second electromagnetic radiation sources using a modulation scheme selected from the group consisting of: amplitude modulation, phase modulation, and frequency modulation.
